(19) United States
(12) Patent Application Publication
(10) Pub. No.: US 2025/0315317 A1
(43) Pub. Date: Oct. 9, 2025

(54) ASYNCHRONOUS HARDWARE CONTROL CIRCUITRY

(71) Applicant: Nordic Semiconductor ASA, Trondheim (NO)

(72) Inventors: Kaja GAUSDAL, Trondheim (NO); Kyrre GONSHOLT, Trondheim (NO)

(73) Assignee: Nordic Semiconductor ASA, Trondheim (NO)

(21) Appl. No.: 19/172,021

(22) Filed: Apr. 7, 2025

(30) Foreign Application Priority Data
Apr. 9, 2024 (GB) 2405060.1

(51) Int. Cl. G06F 9/52

(52) U.S. Cl. CPC G06F 9/52

(57) ABSTRACT

Asynchronous hardware control circuitry comprises a hardware mutex for interrupting a succession of performances of a hardware or software process. In response to receiving an indication of readiness to start a next performance of the process, if the mutex is unacquired, the control circuitry switches the mutex to a first acquired state and outputs a request to start the next performance. In response to receiving an indication that a performance has completed, if the mutex is in the first acquired state, the control circuitry releases the mutex from the first acquired state. In response to receiving a request to interrupt the succession of performances, if the mutex is unacquired, the control circuitry switches the mutex to the second acquired state. If the mutex is in the first acquired state, the mutex is switched into the second acquired state after the mutex is released from the first acquired state.

### CROSS-REFERENCE TO RELATED APPLICATION

This application claims priority from United Kingdom Patent Application No. 2405060.1, filed Apr. 9, 2024, which application is incorporated herein by reference in its entirety.

### TECHNICAL FIELD

The disclosure is directed to asynchronous hardware control circuitry for controlling performances of a hardware or software process.

### BACKGROUND

Some concurrent processes on an integrated circuit (e.g. a system-on-chip) may be asynchronous to each other. One or more of the processes may be un-clocked (e.g. implemented with asynchronous logic circuitry), or the processes may be performed by synchronous circuits located in different respective clock domains, i.e. being clocked by different clocks. It can be especially difficult to synchronize such processes so that they execute their respective functions without error. In particular, there are situations where a repeating process is executing asynchronously to another process that desires to interrupt it. It is not straightforward for such an interruption to occur without causing errors.

Embodiments of the present disclosure seek to provide an improved approach for asynchronously interrupting a succession of performances of a process.

### SUMMARY

From a first aspect, the disclosure provides asynchronous hardware control circuitry for interrupting a succession of performances of a hardware or software process, the control circuitry comprising:
a first input for receiving an indication that a performance of the hardware or software process has completed, and for receiving an indication of readiness to start a next performance of the process;
a second input for receiving a request to interrupt the succession of performances of the process;
a first output for outputting a request to start the next performance of the process; and
a hardware mutex, switchable between at least a first acquired state, a second acquired state, and an unacquired state;
   wherein the asynchronous hardware control circuitry is configured:
in response to receiving, at the first input, an indication of readiness to start a next performance of the process, if the mutex is in the unacquired state, to switch the mutex to the first (“acquired-by-process”) acquired state and output, from the first output, a request to start the next performance of the process, and, if the mutex is in the second (“acquired-by-interrupt”) state, not to output the request to start the next performance of the process;
in response to receiving, at the first input, an indication that a performance of the process has completed, if the mutex is in the first (“acquired-by-process”) acquired state, to release the mutex from the first acquired state; and
in response to receiving, at the second input, a request to interrupt the succession of performances of the process:
   if the mutex is in the unacquired state, to switch the mutex to the second (“acquired-by-interrupt”) acquired state; and
   if the mutex is in the first (“acquired-by-process”) acquired state, to cause the mutex to switch into the second (“acquired-by-interrupt”) acquired state after the mutex is released from the first acquired state.

From a second aspect, the disclosure provides an integrated circuit (e.g. a system-on-chip) comprising asynchronous hardware control circuitry as disclosed herein and processing circuitry configured for performing the succession of performances of the process.

Thus it will be seen that, in accordance with embodiments, a request to interrupt the process can be received by the control circuitry at any time while the process is performing the succession of performances of the hardware or software process, and the process can complete its current performance before the mutex is switched to the second (acquired-by-interrupt) acquired state by the control circuitry. This is because releasing the mutex from the first acquired state provides an opportunity for the mutex to be switched into the second acquired state (directly or via the unacquired state) in response to the interrupt request, which can then prevent the control circuitry from issuing a request to start a next performance. This arrangement may, at least in some embodiments, enable a succession of performances of the process to be interrupted quickly but safely.

This approach, based on asynchronous logic, may enable reliable control of the process, even when the process is asynchronous to the circuitry requesting the interrupt. At least some embodiments may be faster and/or use less power than traditional approaches for interrupting a process or arbitrating between processes, compared to, for example, a token-ring implementation where a token must be passed between several different asynchronous processes every time that one of the processes completes a task.

By outputting a request to start the next performance of the process, in response to the indication of readiness to start the next performance from the process, when the mutex is not in the second acquired state, the next performance of the process may start as soon as it is possible to do so. This may reduce latency in the performances of the process, whilst still providing an opportunity for the performances to be interrupted.

Thus, embodiments may be particularly useful for controlling a process that is required to run a succession of performances continually, but that still needs to be interrupted on demand.

The first input may comprise connections to a plurality of signal lines, but may be a connection to a single hardware line. It may be communicatively coupled to a source (e.g. processing circuitry as disclosed herein) comprising a processor and/or application-specific hardware circuitry (e.g. configured to perform the hardware or software process). The second input may comprise connections to a plurality of signal lines, but may be a connection to a single hardware line. It may be communicatively coupled to a source comprising a processor and/or application-specific hardware circuitry.

Any hardware line disclosed herein may be configured to be switched from a respective first (e.g. high) state to a respective second (e.g. low) state (e.g. set to logic 1 or 0), also referred to herein as being asserted, and from the second state to the first state, also referred to herein as being de-asserted. In embodiments where the first input is a single hardware line, the indication that a performance of the process has completed may comprise the hardware line being asserted, and the indication of readiness to start a next performance of the process may comprise the hardware line being de-asserted.

The asynchronous nature of the hardware control circuitry advantageously enables it to be used to control a repeating process that is not synchronized with the source of the request for interrupting the process, e.g. because they are in different clock domains, or because one or more of the sources of the first input and second input are un-clocked. In some embodiments, all of the hardware control circuitry is asynchronous (i.e. un-clocked) circuitry. In some embodiments, a source (e.g. the circuitry for performing the process) communicatively coupled to the first input is in a first clock domain and a source (e.g. interrupting circuitry) communicatively coupled to the second input is in a second clock domain, wherein the first clock domain is different from the second clock domain. The first and second clock domains may be independently clocked—e.g. at different clock frequencies and/or by different oscillators.

In some embodiments, the first input is communicatively coupled to a processing system for performing the process. The process may be implemented by processing circuitry comprising a processor and/or application-specific hardware circuitry. The process may be a software process (e.g. comprising instructions stored in a memory of the processing circuitry), but in a set of embodiments it is a hardware process comprising hardware processing circuitry for carrying out the process. The hardware processing circuitry may be directly coupled to the first input of the control circuitry by a single hardware line. This may advantageously reduce latency associated with the control of the process by providing a direct indication to the control circuitry that a performance of the process has completed, allowing the mutex to be switched into the unacquired state in response to (e.g. immediately after) the performance has completed. This may allow the interruption of the process to be implemented more quickly. The process may be un-clocked or may be clocked by a different clock from the source of the second input.

Each performance in the succession of performances may comprise a set of one or more actions. The process may be configured to output the indication that a performance has completed after each performance in the succession of performances. The set of actions in each performance may be grouped such that it is safe to interrupt the process after the last action in each performance has completed; however, the actions may be such that it is not always safe to interrupt the process while it is being performed.

In some embodiments the succession of performances comprises running the same performance repeatedly—i.e. the process may be configured to execute an identical or similar set of actions at each performance. However, alternatively, the succession of performances may comprise one or more performances which have a different set of actions to another performance in the succession.

The control circuitry may comprise a third input for receiving a request to initiate the succession of performances of the process. The request may be received from an initiating subsystem. The asynchronous hardware control circuitry may be configured, in response to receiving, at the third input, a request to initiate the process performances, if the mutex is in the second acquired state, to release the mutex from the second acquired state—e.g. to switch the mutex to the unacquired state. Releasing the mutex from the second acquired state provides an opportunity for the mutex to be switched into the first acquired state (directly or via the unacquired state) in response to an indication of readiness to start the next performance of the process.

The control circuitry may be configured to receive requests to interrupt the succession of performances of the process and/or requests to initiate the succession of performances of the process from any of a plurality of sources (e.g. from a plurality of other processes). The control circuitry may comprise a plurality of interrupt-request inputs (e.g. a plurality of interrupt-request input lines), including the second input, for receiving requests to interrupt the succession of performances of the process from any of the plurality of sources. A source of the request to interrupt the succession of performances of the process may be referred to as an “interrupting source”.

Each source may comprise respective electronic circuitry (e.g. sequential logic circuitry) configured to generate the respective requests to interrupt the process and/or initiate the succession of performances of the process. Each request may be generated by a hardware process or by a software process. Each request input may be coupled to a respective source outside the control circuitry. Each source may comprise a processor and/or application-specific hardware circuitry. Two or more of the plurality of request inputs may be coupled to a same source, or each of the plurality of request inputs may be coupled to a different respective source. Each of the request sources may be un-clocked or may be clocked by a different clock from any of the other change-request sources.

The control circuitry may be configured to receive a request to interrupt and/or a request to initiate the succession of performances of the process as a pulse at corresponding input, which may cease before the performances are interrupted or initiated. Thus, a requesting process coupled to the second input line may request to interrupt the succession of performances of the process by sending a pulse, instead of having to continuously assert the second input while the control circuitry interrupts the succession of performances of the process. For example, an interrupting source may assert an interrupt-request line to the second input or further input, and then de-assert the line before the succession of performances of the process is interrupted, with the control circuitry then implementing the requested interruption. This can allow an interrupting source to continue performing other operations after requesting to interrupt the succession of performances of the process, rather than being stalled.

This holding of a request (e.g. a pulsed request) may be implemented in any appropriate way. The control circuitry may comprise a latch (e.g. within an asynchronous wait block), and may be configured to set the latch in response to receiving a request to interrupt the succession of performances of the process at the second input. It may be configured to latch every request received at the second input. The control circuitry may comprise sampling logic for sampling the latch to detect the request. The control circuitry may be configured to sample the latch to detect the request before switching the mutex to the second acquired state if the mutex is in the unacquired state.

The first output may additionally be for outputting an acknowledgement of the indication that a performance of the process has completed. The control circuitry may be configured, in response to the mutex being switched into the first acquired state, to output, from the first output, a request to start the next performance of the process. The control circuitry may be configured, in response to the mutex being released from the first acquired state (e.g. switched to an unacquired state) following the receipt of an indication that a performance of the process has completed, to output, from the first output, an acknowledgement of the indication that the performance has completed. The first output may be communicatively coupled to the process. The first output may comprise connections to a plurality of signal lines, but may be a connection to a single hardware line. The request to start the next performance of the process may comprise the hardware line being asserted, and the acknowledgement of the indication that a performance of the process has completed may comprise the hardware line being de-asserted.

The control circuitry may comprise a second output for outputting an acknowledgement of the request to interrupt the succession of performances of the process. The second output may also be for outputting an indication that the process is running. The second output may be a connection to a single hardware line. The control circuitry may be configured, in response to the mutex being switched to the first acquired state, to output, from the second output, an indication that the process is running. This may advantageously ensure that a request to interrupt the succession of performances of the process is not received when the process is not running. The control circuitry may be configured, in response to receiving the request the interrupt the succession of performances of the process, to output, from the second output, an acknowledgment of the request to interrupt the succession of performances of the process. The acknowledgement of the request to interrupt the succession of performances of the process and the indication that the process is running may be output to the interrupting source. In a set of embodiments, the control circuitry may be configured to output the acknowledgment of the request to interrupt the succession of performances of the process in immediate response to receiving the request to interrupt the succession of performances of the process, agnostic of whether the process has been interrupted yet. The interrupting source may be configured to de-assert the request to interrupt the succession of performances of the process in response to receiving the acknowledgement of the request to interrupt the process. If the control circuitry is configured to receive a request to interrupt the process as a continuously-held assertion on the second input line (rather than a pulse), the interrupting source may cease the held assertion in response to receiving the acknowledgement of the request to interrupt the succession of performances of the process.

The control circuitry may comprise a third output for outputting an indication that the process has been interrupted. The asynchronous hardware control circuitry may be configured, in response to determining that the mutex has been switched to the second acquired state, to output, from the third output, an indication that the succession of performances of the process has been interrupted. Outputting an indication that the succession of performances of the process has been interrupted may advantageously provide an indication that other processes can carry out their respective tasks.

In some embodiments, the indication that the succession of performances of the process has been interrupted is output to a subsystem (e.g. the initiating subsystem disclosed above) which is different to the interrupting source. If the control circuitry is configured to receive a request to initiate the succession of performances of the process as a continuously-held assertion on the third input line (rather than a pulse), the initiating subsystem may be configured to cease the held assertion in response to receiving the indication that the succession of performances of the process has been interrupted.

In other embodiments, the indication that the succession of performances of the process has been interrupted may be output to the interrupting source. If the control circuitry is configured to receive a request to interrupt the process as a continuously-held assertion on the second input line (rather than a pulse), the interrupting source may cease the held assertion in response to receiving the indication that the succession of performances of the process has been interrupted.

The mutex may comprise a plurality of mutex-request inputs (e.g. two mutex-request input lines), each arranged for receiving a respective request to switch to a respective acquired state (also referred to herein as acquiring the mutex). The mutex may comprise a corresponding plurality of mutex-grant outputs (e.g. two mutex-grant output lines). Each mutex-request input may have an associated mutex-grant output. Each mutex-request input and mutex-grant output may comprise a single line implemented in hardware which is configured to be switched between a first (e.g. high) state and a second (e.g. low) state (i.e. set to 1 or 0), also referred to herein as being asserted and de-asserted, in the respective directions. A first (e.g. high) state of a request input line may correspond to a request to acquire the mutex. A first (e.g. high) state of a grant output line may correspond to the mutex being successfully acquired by the corresponding request input. The mutex may be configured such that only one of the mutex-grant output lines can be set to a first (e.g. high) state at one time, i.e. such that the grant outputs are mutually exclusive. Consequently, the mutex may only be acquired by one request input at any time. If one of the grant output lines of the mutex is set to the first (e.g. high) state, the mutex can be said to be in an acquired state associated with that grant output line. If none of the grant output lines are set to the first (e.g. high) state, the synchronization mutex can be said to be in the unacquired state.

The mutex may be configured, when in the unacquired state, to switch to an acquired state in response to a first-received request at any of the plurality of mutex-request inputs. It may be configured to indicate at which mutex-request input the first-received request was received, e.g. by asserting a corresponding one of the plurality of mutex-grant outputs. At least in some examples, the mutex is configured to remain in the corresponding acquired state for as long as the first-received request is maintained—i.e. at least until the mutex-request input at which the first-received request was received is de-asserted. It may be configured to switch to the unacquired state (also referred herein as being released) in response to a cessation of the first-received request—i.e. to the corresponding mutex-request input being de-asserted. In some embodiments, the mutex may be able to switch directly from a first acquired state to a second acquired state, e.g. if a second mutex-request input is already asserted when a first mutex-request input is de-asserted. For the purposes of the present disclosure, the mutex may still be regarded as passing through the unacquired state, albeit only momentarily or notionally, in such situations.

The mutex may comprise n mutex-request inputs and n mutex-grant outputs, and be configured to provide mutual exclusion between up to n requests to acquire the mutex, where n=2, 3 or more. Where n>2, the mutex may comprise a plurality of electrically coupled mutex circuit elements, each mutex circuit element having two request inputs and two grant outputs.

The first acquired state of the mutex may be referred to as the mutex being acquired by the process. The second acquired state of the mutex may be referred to as the mutex being acquired by the control circuitry, e.g. when the control circuitry has acquired the mutex to interrupt the succession of performances of the process. The unacquired state of the mutex may be referred to as the mutex being available. Switching from an acquired state to the unacquired state may be referred to as the mutex being released.

The control circuitry may be configured to switch the mutex to the first acquired state by asserting a first mutex-request input and may be configured to release the mutex from the first acquired state by de-asserting the first mutex-request input. Switching the mutex into the first acquired state causes a first mutex-grant output to be asserted and releasing the mutex from the first acquired state causes the first mutex-grant output to be de-asserted. The control circuitry may be configured to switch the mutex to the second acquired state by asserting a second mutex-request input and may be configured to release the mutex from the second acquired state by de-asserting the second mutex-request input. Switching the mutex into the second acquired state causes a second mutex-grant output to be asserted and releasing the mutex from the second acquired state causes the second mutex-grant output to be de-asserted.

The control circuitry may be configured, upon reset or start-up, to de-assert the first mutex-request input, such that the process does not immediately acquire the mutex following start-up. The control circuitry may comprise a fourth input for receiving a request to reset the control-circuitry, and the control circuitry may be configured such that the first mutex-request input cannot be asserted while the re-set of the control circuitry is being requested. Upon start-up of the control circuitry, the control circuitry may be configured to assert the second mutex-request input, such that by default, the mutex is acquired by the control circuitry.

In some embodiments, the first input is connected to the first mutex-request input line. In response to receiving, at the first input, an indication of readiness to start the next performance of the process, the control circuitry may be configured to assert the first mutex-request input. Asserting the first mutex-request input can thus be understood to be a request that the mutex is switched to the first acquired state (acquired by the process). In response to receiving, at the first input, an indication that a performance of the process has completed, the control circuitry may be configured to de-assert the first mutex-request input. De-asserting the first mutex-request input can thus be understood to be a request to switch the mutex to an unacquired state—i.e. to release the mutex from the first acquired state. De-asserting the first mutex-request input thus provides an opportunity for the process to be interrupted, by releasing the mutex.

The default state of the first input may be to indicate readiness to start the next performance of the process, and thus, by default, the control circuitry may be configured to assert the first mutex-request input. By asserting the first mutex-request input by default, the mutex will be switched into the first acquired state (i.e. acquired by the process) at the first opportunity—i.e. as soon as the mutex is momentarily in the unacquired state. This may advantageously reduce the time before the process starts running again following an interrupt. However, in some embodiments, the control circuitry may be configured such that when a request to reset the control circuitry is received at the fourth input, the first mutex-request input is not asserted, even when the control circuitry receives an indication of readiness to start the next performance of the process. For example, the fourth input and the first input may both be connected to a logic gate configured to implement this constraint, and the output of the logic gate may be connected to the first mutex-grant request line.

In some embodiments, the first output is connected to the first mutex-grant output line. The control circuitry may be configured, in response to the first mutex-grant output being asserted—i.e. in response to the mutex being switched to the first acquired state (acquired by the process), to output, from the first output, a request to start the next performance of the process. Otherwise, when the mutex is not in the first acquired state (e.g. when it is in the unacquired state or in the second acquired state), the first mutex-grant output is de-asserted, and control circuitry may be configured not to output the request to start the next performance of the process at the first output.

In some embodiments, the control circuitry may be configured, in response to receiving the request to interrupt the succession of performances of the process at the second input, to assert the second mutex-request input. Asserting the second mutex-request input can thus be understood to be a request that the mutex is switched to the second acquired state (acquired by the control circuitry).

As described above, when the process has acquired the mutex, the mutex is configured to remain in the first acquired state irrespective of whether the second mutex-request input is asserted or not. Thus, the corresponding second mutex-grant output will remain de-asserted while a performance of the process is running. In accordance with the operation of the control circuitry described above, the mutex will be released by the process in response to the control circuity receiving an indication that a performance of the process has completed. In accordance with the operation of the mutex described above, when the process releases the mutex while the second mutex-request input is asserted, the second mutex-grant output will be asserted, indicating that the mutex has been switched to the second acquired state (i.e. acquired by the control circuitry).

In some embodiments, the control circuitry may be configured, in response to the second mutex-grant output being asserted—i.e. in response to the mutex being switched to the second acquired state, to output an indication that the process has been interrupted at the second output.

In some embodiments, the control circuitry may be configured, in response to receiving the request to initiate performances of the process at the third input, to de-assert the second mutex-request input. De-asserting the second mutex-request input can thus be understood to be the same as switching the mutex to the unacquired state—i.e. releasing the mutex from the second acquired state. By releasing the mutex, the mutex can then be switched into the first acquired state—i.e. acquired by the process—when the first mutex-request input is asserted.

The second input and/or third input may be directly connected to the second mutex-request input. However, in some embodiments, the control circuitry comprises an interface logic portion which is connected to the second input for receiving a request to interrupt the succession of performances of the process. The interface logic portion may also be connected to the third input for receiving a request to initiate the succession of performances of the process. The interface logic portion may be connected to the second mutex-request input.

In such embodiments, the interface logic portion may be configured, in response to receiving a request to interrupt the succession of performances of the process at the second input, to assert the second mutex-request input. The interface logic portion may be configured, in response to receiving a request to initiate the succession of performances of the process at the third input, to de-assert the second mutex-request input. The interface logic may implement a time delay between receiving the requests at the second and third input, and asserting/de-asserting the second mutex-request input respectively.

The second output may be directly connected to the second mutex-grant output. However, in some embodiments, the interface logic portion may be connected to the second output for outputting an indication that the succession of performances of the process has been interrupted. The interface logic portion may also be connected to the third output for outputting an acknowledgement of the request to interrupt the succession of performances of the process. The interface logic portion may be connected to the second mutex-grant output. The interface logic may be configured to, in response to the second mutex-grant output being asserted, output an indication that the succession of performances of the process has been interrupted at the second output.

The interface logic may be configured, in response to receiving the request to interrupt the succession of performances of the process at the second input, to output an acknowledgment of the request to interrupt the succession of performances of the process at the third output.

Thus, the interrupting source may handshake with the interface logic portion when the control circuitry receives the request to interrupt the succession of performances of the process, without having any direct interaction with the mutex. Having an interface logic portion may advantageously allow the control circuitry to have greater control over when the second mutex-request input is asserted or de-asserted in response to receiving an input request form the source(s) of the respective requests. For example, the interface logic portion may arbitrate between requests at the second input and the third input.

The request to interrupt the process at the second input may be captured by the interface logic portion by any means, e.g. by a latch. In such embodiments, the second mutex-request input may be asserted by the interface logic portion in response to the first mutex-grant output being de-asserted (i.e. in response to the mutex being switched into the unacquired state after a performance of the process has completed). However, in some embodiments, the interface logic portion is configured to assert the second mutex-request input immediately after receiving the request to interrupt the succession of performances of the process, and only configured to de-assert the first mutex-request input in response to the first-mutex grant output being asserted by the mutex (i.e. in response to the mutex being switched in the second acquired state-acquired by the control circuity).

The asynchronous hardware control circuitry may be provided as part of an integrated circuit (e.g. a system-on-chip). The integrated circuit may further comprise processing circuitry for implementing the succession of performances of the process.

An integrated circuit as disclosed herein may further comprise the initiating subsystem and/or the interrupting source.

The processing circuitry for implementing the succession of performances of the hardware or software process may comprise a processing-circuitry-input for receiving, from the control circuitry, a request to start the next performance of the process and for receiving, from the control circuitry, an acknowledgement of the indication that a performance of the process has completed. It may comprise a processing-circuitry-output for outputting, to the control circuitry, the indication that the performance has completed and for outputting, to the control circuitry, the indication of readiness to start the next performance of the process. The processing circuitry may be configured, in response to receiving, at the processing-circuitry-input, a request to start the next performance of the process, to carry out a performance of the process. It may be further configured, in response to completing the performance, to output, from the processing-circuitry-output, an indication that a performance of the process has completed. It may be further configured, in response to receiving, at the processing-circuitry-input, an acknowledgement from the control circuitry of the indication that the performance has completed, to output, from the processing-circuitry-output, an indication of readiness to start the next performance of the process.

In some embodiments the processing circuitry is configured, after a performance has been carried out by the process, to output the indication of readiness to start the next performance of the process only in response to receiving, from the control circuitry, an acknowledgement of the indication that a performance of process has completed. This handshake arrangement allows the mutex to be released momentarily as described above after the performance has completed, allowing an interrupt to take effect if one has been requested. However, if no interrupt has been requested, the next performance of the process can be started straight away. This minimises the delay between each performance, allowing the process to continuously run with minimal pause between performances when no interruption has been requested.

The processing circuitry may comprise a processor for executing software instructions and/or application-specific hardware circuitry. In a set of embodiments, the processing circuitry comprises hardware processing circuitry for carrying out the process (i.e. not using software). The process may be configured to run the same performance repeatedly—i.e. it may perform an identical or similar set of actions at each performance. However, in some embodiments, it may process different data or inputs, or have a different state, in some performances compared with other performances. In some embodiments the process may be iterative. In some embodiments the performances of the process may be performed continually until interrupted.

Each of the processing-circuitry-inputs and processing-circuitry-outputs may be directly coupled to the control circuitry by respective single hardware lines.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the disclosure will now be described, by way of example only, with reference to the accompanying drawings, in which:

FIG. 1 is a schematic diagram of a portion of an integrated circuit embodying the disclosure;

FIG. 2 is a schematic diagram showing a more detailed view of the control circuitry of the integrated circuit portion shown in FIG. 1;

FIG. 3 is signal transition diagram showing the effect of the sequence of logical operations carried out by the control circuitry shown in FIG. 2; and FIG. 4 is a signal timing diagram which corresponds to the signal transition diagram shown in FIG. 3.

### DETAILED DESCRIPTION

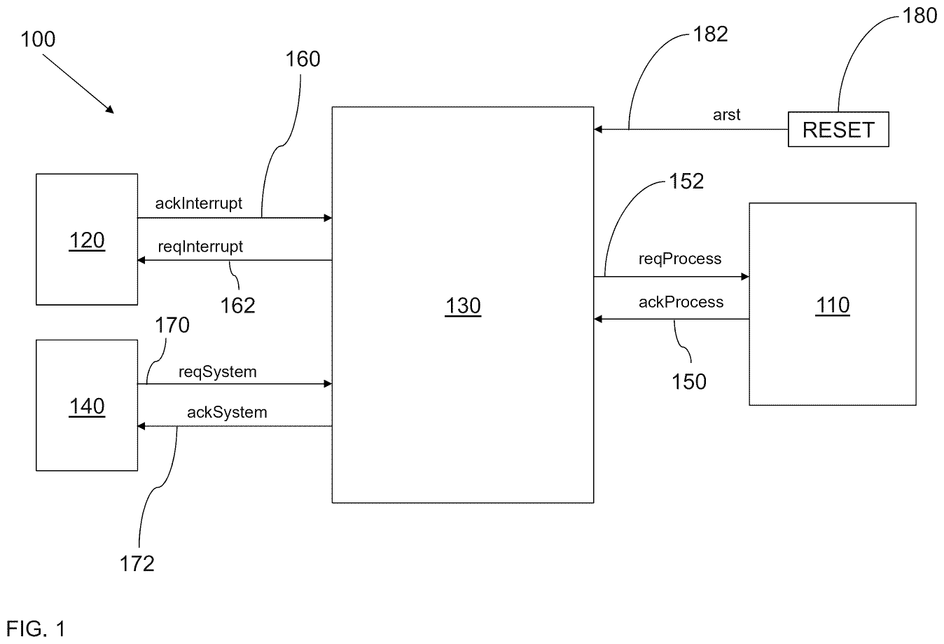

FIG. 1 is a schematic diagram of a portion of an integrated circuit 100 (e.g. a system-on-chip) embodying the disclosure. A repeating process 110 and an interrupting process 120 are coupled to control circuitry 130. FIG. 1 shows a further controlling process 140 which is coupled to the control circuitry 130. One or more further processes may be coupled to the control circuitry 130. The processes 110, 120 and 130 may both be clocked by the same clock, or they may be in different clock domains, clocked by independent clocks, or one or both of the processes 110, 120 may be clockless. Each process 110, 120 may be a software process (i.e. executing on a respective processor) or a hardware process (e.g. implemented by application-specific digital logic circuitry). In the embodiments described in detail, the repeating process 110 is a hardware process implemented by hardware circuitry, and the hardware circuitry of the repeating process is configured to repeatedly carry out a predetermined sequence of logical operations. A predetermined sequence of logical operations may be referred to as a performance of the repeating process. Although the examples described herein refer to a repeating process, it is equally envisaged that the ideas disclosed herein may be applicable to other processes which carry out one or more different sequences of logical operations, and which may be performed a succession of times.

In the example described in detail herein, during typical operation of the integrated circuit 100, the repeating process 110 is configured to repeat the predetermined sequence of logical operations indefinitely, unless prevented from doing so by the control circuitry 130. The control circuitry 130 may be configured to prevent the repeating process 110 from running in response to input from the interrupting process 120 and/or the further controlling process 140.

In one example, the interrupting process 120, at some point in its operation, is required to request to interrupt the repeating process 110. However, the timing of this request cannot be straightforwardly coordinated, especially as the processes 110 and 120 operate in different clock domains. As a result, it is possible that the interrupting process 120 tries to interrupt the repeating process 110 at a point in time which is detrimental to the operation of the integrated circuit 100. For example, if the repeating process 110 is interrupted in the middle of one of the predetermined sequences of logical operations, it may cause an error which prevents the repeating process from running correctly again when the interruption is removed. The control circuitry 130 is arranged to prevent the repeating process 110 from being interrupted during the middle of a performance, instead causing the repeating process 110 to be interrupted immediately following the end of the current performance which the repeating process 110 is carrying out when the interrupt request is received.

As shown in FIG. 1, the repeating process 110 is connected to the control circuitry 130 by a first single-bit hardware input line 150 and a first single-bit hardware output line 152. The interrupting process 120 is connected to the control circuitry 130 by a second single-bit hardware input line 160 and a second single-bit hardware output line 162. The controlling process 140 is connected to the control circuitry 130 by a third single-bit hardware input line 170 and a third single-bit hardware output line 172. The RESET input 180 is connected to the control circuitry 130 by a fourth single-bit hardware input line 182.

In the example shown in FIG. 1, the control circuitry 130 is configured to receive the signal ackProcess from the repeating process 110 on the first input line 150. The signal ackProcess is used for sending an indication to the control circuitry 130 that a performance of the process has completed and for sending an indication of readiness to start a next performance of the repeating process 110 to the control circuitry 130. By switching ackProcess from a low state to a high state, the repeating process 110 is configured to indicate to the control circuitry 130 that a performance of the process has completed after each performance, and, by switching from high to low state, is configured to output an indication of readiness to start the next performance of the repeating process 110 shortly thereafter. This sequence of input signals to the control circuitry 130 from the repeating process 110 creates an opportunity for the control circuitry 130 to interrupt the repeating process 110.

The control circuitry 130 is configured to output the signal reqProcess to the repeating process 110 on the first output line 152. The signal reqProcess is used for sending, from the control circuitry 130 to the repeating process 110, a request to start the next performance of the process (when set high), and for sending, from the control circuitry 130, an acknowledgement of the indication that the performance has completed (when set low). Providing these two different outputs can be implemented by switching reqProcess between a high and low state and vice versa.

The control circuitry 130 is configured to receive the signal ackInterrupt from the interrupting process 120 on the second input line 160. The signal ackInterrupt is used for receiving a request to interrupt the repeating process 110. The request from the interrupting process 120 to interrupt the repeating process 110 may thus be implemented by changing the value of the second input line 160—e.g. asserting the request by setting the value of the second input line 160 to logic high.

The control circuitry 130 is configured to output the signal reqInterrupt to the interrupting process 120 on the second output line 162. The signal reqInterrupt is used both for sending an indication from the control circuitry 130 to the interrupting process 120 that the repeating process 110 is running (i.e. that the control circuitry 130 is ready to receive an interrupt), and for sending an acknowledgement from the control circuitry 130 to the interrupting process 120 that the request to interrupt the repeating process 110 has been received by the control circuitry 130. The indication from the control circuitry 130 that the repeating process 110 is running may thus be implemented by changing the value of the second output line 162—e.g. by setting the value of the second output line 162 to logic low. The acknowledgment from the control circuitry 130 that the request to interrupt the repeating process 110 has been received may also be implemented by changing the value of the second output line 162—e.g. by setting the value of the second output line 162 to logic high.

The interrupting process 120 may be configured to assert the request to interrupt the repeating process 110 when an interruption is required, and to de-assert the request to interrupt the repeating process 110 in response to receiving the acknowledgment output signal reqInterrupt from the control circuitry 130. In other words, to request to interrupt the repeating process 110, the interrupting process 120 undergoes a 4-phase handshake with the control circuitry 130.

The control circuitry 130 is configured to receive the signal reqSystem from the controlling process 140 on the third input line 170. The signal reqSystem is used for sending a request to initiate the repeating process 110 from the controlling process 140 to the control circuitry 130. The request from the controlling process 140 may thus be implemented by changing the value of the third input line 170—e.g. by setting the value of the third input line 170 to logic high.

The control circuitry 130 is configured to output the signal ackSystem to the interrupting process 120 on the third output line 172. The signal ackSystem is used for sending an indication from the control circuitry 130 to the controlling process 140 that the repeating process 110 has been interrupted by the control circuitry 130. The indication from the control circuitry 130 that the repeating process 110 has been interrupted may thus be implemented by changing the value of the third output line 172—e.g. by setting the value of the third output line 172 to logic high.

The controlling process 140 is configured to assert the request to initiate the repeating process 110 when the repeating process 110 should start running, and to de-assert the request to initiate the repeating process 110 in response to receiving the output signal ackSystem from the control circuitry 130.

Note that in some instances, input signals that are herein referred to as “requests”—e.g. a request to interrupt a continuously repeating process, are labelled as an acknowledgement—e.g. ackInterrupt. The semantic names of each input and output signal described herein are merely labels for illustrative purposes and not intended to be limiting in their interpretation. For example, reqInterrupt could be considered a request from the control circuitry 130 for an interrupt from the interrupting process 120 (by indicating that the control circuitry 130 is ready to receive an interrupt after the repeating process 110 has started running).

The control circuitry 130 is further configured to receive an asynchronous, active-low reset signal arstn from a RESET input 180 on the fourth input line 182. The arstn signal is used for re-setting the control circuitry 130, e.g. after the integrated circuit 100 has been powered down and re-started.

Although FIG. 1 only shows one hardware input line 150, 160, 170 from each of the processes 110, 120, 140, it is envisaged that in some examples more than one input line could be used to connect each process 110, 120, 140 and the control circuitry 130. For example, instead of the first input line 150 being used both for receiving an indication that a performance of the process has completed, and for receiving an indication of readiness to start the next performance of the repeating process 110 (by setting the value of the line to a high and low state respectively), two separate input lines could be used for receiving each of these indications from the repeating process 110. However, implementing the inputs 150, 160, 170 to the control circuitry 130 from the processes 110, 120, 140 using respective single-bit hardware input lines 150 may advantageously reduce the area of the chip required to implement the integrated circuit 100, and reduce complexity of the system.

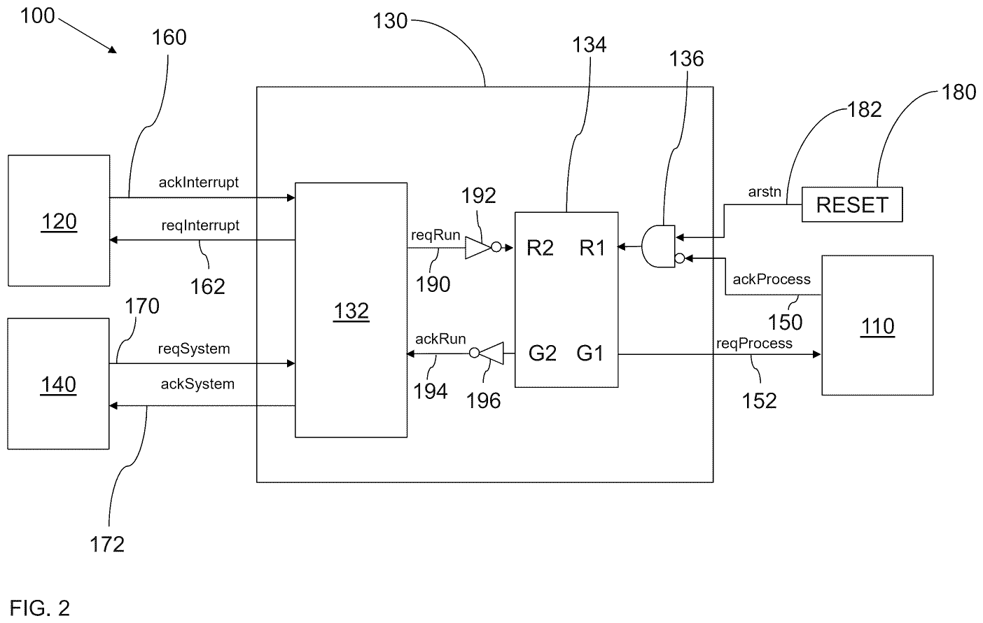

FIG. 2 is a schematic diagram showing a more detailed view of the control circuitry 130 of the integrated circuit portion 100 shown in FIG. 1. The control circuitry 130 comprises interface circuitry 132 and a hardware mutex 134.

The mutex 134 has two request inputs (labelled as R1 and R2) as well as two grant outputs (labelled as G1 and G2). The request input R1 corresponds to the grant output G1, and the request input R2 corresponds to the grant output G2. The mutex 134 ensures mutual exclusion between granting requests from the two inputs—it may do so using a bistable and a metastability filter in accordance with the typical construction of a mutex element. In operation, if a request to acquire the mutex 134 has been asserted on a first one of the input lines, e.g. R1, the corresponding grant output line, e.g. G1, is set to a high state. This operation switches the mutex 134 to an acquired state (e.g. a first acquired state if R1 is asserted, or a second acquired state if R2 is asserted), and the process that set the input high is said to have acquired the mutex 134. If a request to acquire the mutex 134 is then received on the other input line, e.g. R2, the mutex 134 remains acquired by the request on the first input line, e.g. R1.

Once the request on the first input line, e.g. R1, is de-asserted, i.e. set to a low state, the mutex 134 switches to an unacquired state, and is said to have been released. It is then available to be requested again by a request on either request input line R1 or R2.

In some situations, one input line (e.g. R2) may be asserted while the other input line (e.g. R1) is already asserted and the corresponding grant output line (e.g. G1) is set to a high state. In this case, when the input line (e.g. R1) that has acquired the mutex 134 is de-asserted, the mutex 134 may subsequently indicate that the request at R2 is granted by setting the output line G2 to a high state. To achieve this, the mutex element 134 might set G1 to a low state then, after a short interval, raise G2 to a high state, or it might raise G2 to a high state then, after a short interval, lower G1 to a low state. The width of this time interval can be so small (femtoseconds or attoseconds) that it appears that G1 and G2 exchange states at the same time, or it may be large enough that it is observable (i.e. of the order of picoseconds or nanoseconds). In all cases, the mutex 134 can be considered to pass through an unacquired state, at least momentarily, when switching from a first acquired state to a second acquired state.

The precise operation of the mutex 134 may depend on a plurality of factors including the voltage, temperature and also on the physical implementation of the mutex 134 and the load on the outputs G1 and G2.

As shown in FIG. 2, the repeating process 110 is connected to the mutex 134 of the control circuitry 130 by the first input line 150 and the first output line 152. In some examples, the connection between the mutex 134 and the first input line 150 may be a direct connection, but in the example shown in FIG. 2, the first input line 150 from the repeating process 110 and the fourth input line 182 from the RESET input 180 are connected to the first request input R1 of the mutex 134 via a logic gate 136. The logic gate 136 is configured to receive the signal ackProcess from the repeating process 110, and the repeating process 110 is configured to receive the signal reqProcess from first grant output G1 of the mutex.

The logic gate 136 is configured such that the first request input R1 of the mutex 134 is set to a high state when the first input line 150 is set to a high state and the fourth input line 182 is set to a low state. This may be the case where the input from the RESET input 180 is configured to be set to a high state during normal operation, and configured to switch to a low state when the integrated circuit undergoes a re-set. In the example shown this is implemented as an AND-gate with one inverted input for line 150 and non-inverted input for line 182.

It should be noted that in other examples the reset circuitry could be implemented differently, and the ackProcess signal could have a different polarity. In such examples, the logic gate 136 may be configured differently.

Using a logic gate 136 as shown in FIG. 2 to receive an input from the RESET input 180 and the repeating process 110 advantageously ensures that the first request R1 of the mutex 134 is not set to a high state immediately following a re-set of the control circuitry 130—i.e. it ensures that the mutex is not initialized in a state where it is acquired by the repeating process 110. Given that, as explained above, the first input line 150 is used to receive an indication of readiness to start the next performance of the repeating process 110 (i.e. by default, the first input line 150 is set to a high state), using the logic gate 134 prevents the repeating process 110 from acquiring the mutex 134 immediately following a re-set of the control circuitry 130.

The first output line 152 is directly connected to the first grant output G1 of the mutex 134. Thus, as soon as the mutex 134 has been acquired by the repeating process 110 (i.e. the mutex has been switched into the first acquired state), the first grant output G1 of the mutex 136 is set to a high state, and the first output line 152 is also set to a high state.

The interface circuitry 132 is configured to receive the signal ackInterrupt from the interrupting process 120 on the second input line 160. The interface circuitry 132 is configured to receive the signal reqSystem from the controlling process 140 on the third input line 170. The interface circuitry 132 is configured to output the signal reqInterrupt to the interrupting process 120 at the second output line 162. The interface circuitry 132 is configured to output the signal ack System to the controlling process 140 at the third output line 172.

The interface circuitry 132 is configured to output the signal reqRun to the second request input R2 of the mutex 134, via a first intermediate hardware line 190 and a first inverter 192. The interface circuitry 132 is configured to receive the signal ackRun from the second grant output G2 of the mutex 134, via a second intermediate hardware line 194 and a second inverter 196. In this example, the first inverter 192 is introduced such that on start-up of the control circuitry, the second request input R2 of the mutex 134 is initialized in a high state—i.e. the mutex 134 is acquired by the control circuity.

This prevents the repeating process 110 from acquiring the mutex 134 immediately following re-set of the control circuitry 130. The second inverter 196 is used such that the signal ackRun is set to a low state when the mutex 134 is acquired by the control circuitry 130. The inverters 192, 196 are implemented in this instance to uphold the standard polarity of a four-phase handshake. However, it is noted that this could also be achieved by changing the polarity of the reqRun and ackRun signals.

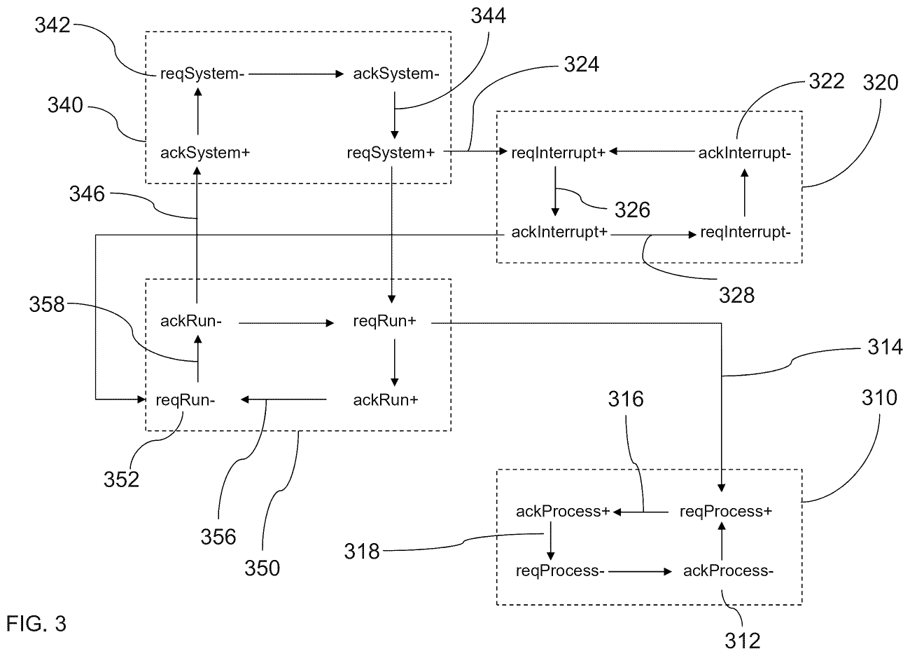

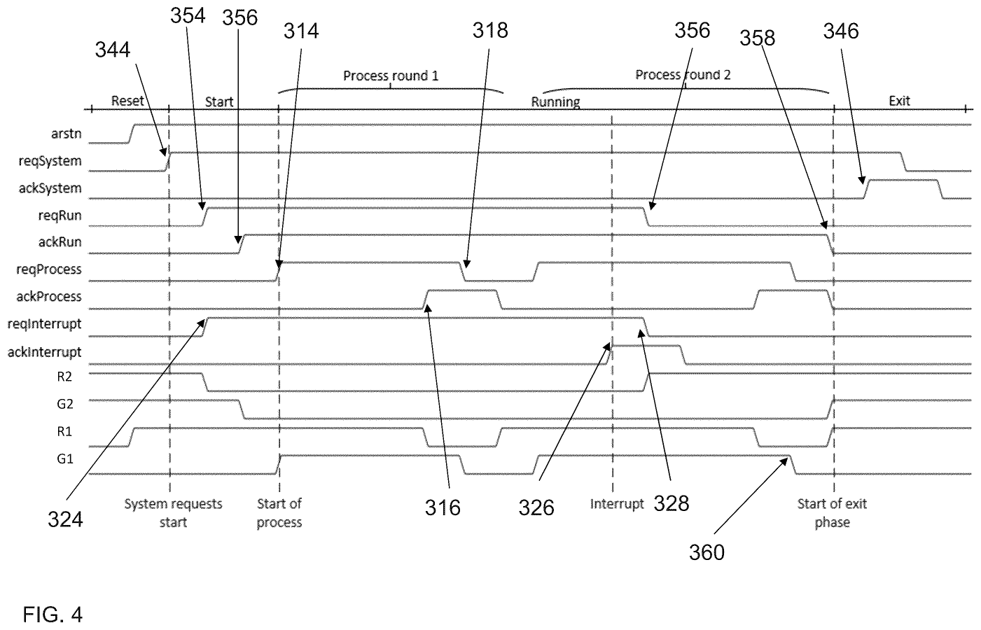

The operation of the control circuitry 130, including the interface circuitry 132, in response to the different input signals is described in more detail with respect to FIGS. 3 and 4.

FIG. 3 is signal transition diagram showing the effect of the sequence of logical operations carried out by the control circuitry 130 in response to the input signals from the repeating process 110, the interrupting process 120, and the controlling process 140. The signals are grouped into repeating process interface signals 310 which interface with the repeating process 110, interrupt interface signals 320 which interface with the interrupting process 120, control interface signals 340 which interface with the controlling process 140 and the internal signals 350 which operate internally to the control circuitry 130. FIG. 4 is a signal timing diagram which corresponds to the signal transition diagram shown in FIG. 3.

On start-up of the integrated circuit, all input and output signals are set to low.

In accordance with the reset state labelled 312, the input signal ackProcess is set to low. As explained above in more detail, on account of the configuration of the logic gate 136, setting ackProcess to low has the effect of requesting to switch the mutex 134 into a state where it is acquired by the repeating process 110, as soon as the reset signal arstn is switched to high (indicating that the re-set has completed). Thus, the default state on start-up of the repeating process 110 is indicating that the repeating process 110 is ready to run the next performance.

In accordance with the reset state labelled 322, the input signal ackInterrupt is set to low—i.e. no interrupt is being requested by the interrupting process 120. In accordance with the reset point labelled 352, the internal signal reqRun is set to a low. As explained above, on account of the first inverter 192 shown in FIG. 2, the second request input R2 of the mutex will be set to a high state, and the mutex will be acquired by the control circuitry 330 as a result.

In accordance with the reset point labelled 342, the input signal reqSystem is set to low—i.e. the controlling process 140 is not yet requesting that performance of the repeating process 110 should be initiated.

To initiate a succession of performances of the process, the controlling process 140 sets the input signal reqSystem high at the signal transition labelled 344 in FIG. 3 and FIG. 4.

In response, the control logic 130 sets the internal signal reqRun to high at the signal transition labelled 354. This has the effect of setting the second mutex-request input R2 to low, thus releasing the mutex 134—i.e. switching the mutex 134 into an unacquired state. As a result, the second mutex-grant output G2 switches to low, which sets the internal signal ackRun to high at the signal transition labelled 356. This indicates to the interface circuitry 132 that the mutex 134 has been released. At the same time as setting the internal signal reqRun to high, the control circuitry 130 sets the output signal reqInterrupt to high at the signal transition labelled 324. This indicates to the interrupting process 120 that the repeating process 110 can now be interrupted.

As explained above, following reset, the first mutex-request input R1 is set to high. Therefore, as soon as the second mutex-grant output G2 is switched to low when the mutex 134 is released, the first mutex-grant output G1 will switch to high. This sets the output signal reqProcess to a high state at the signal transition labelled 314 in FIG. 3 and FIG. 4, outputting a request to start the next performance of the repeating process 110 to the repeating process. The repeating process 110 is configured to then carry out the performance.

In response to the performance of the repeating process 110 being completed, the repeating process 110 is configured to switch the input signal ackProcess to high at the signal transition labelled 316 in FIG. 3 and FIG. 4. This provides an indication to the control circuitry 130 that a performance of the repeating process 110 has completed. Setting ackProcess to high sets the first mutex-request input R1 to low, which in turn causes the mutex 134 to be released, which causes the first mutex-grant output G1 to be switched to low. This causes the output signal reqProcess to be switched to low at the signal transition labelled 318 in FIGS. 3 and 4, providing an acknowledgement to the repeating process of the indication that a performance of the repeating process 110 has completed. In response to the output signal reqProcess being switched to low, the repeating process 110 switches the input signal ackProcess to low again, thus indicating readiness to start the next performance of the repeating process 110, and causing the first mutex-request input R1 to be set to high.

This handshake between the repeating process 110 and the control circuitry 130 provides an opportunity for the repeating process 110 to be interrupted. If, when the first mutex-request input R1 is switched to high again, the mutex 134 has not be acquired by the control circuitry 130, the repeating process 110 will acquire the mutex 134 again, causing the control circuitry 140 to output a request to start the next performance, which causes the repeating process 110 to complete the next performance of the repeating process 110.

At some point during operation of the integrated circuit, the interrupting process 120 requests to interrupt the repeating process 110 by setting the input signal ackInterrupt to high. This is shown at the signal-transition labelled 326 in FIG. 3 and FIG. 4.

In response to ackInterrupt being set to high, the control circuitry 130 sets internal signal reqRun to low at the signal transition labelled 356 in FIG. 3 and FIG. 4. This has the effect of setting the second mutex-request input R1 to high, meaning the control circuitry requests to acquire the mutex 134. At the same time, the control circuitry 130 sets output signal reqInterrupt to low at the signal transition labelled 328, thus outputting an acknowledgement of the request to interrupt the repeating process 110 to the interrupting process 120. In response to receiving this acknowledgement, the interrupting process 120 de-asserts the interrupt request by setting the input signal ackInterrupt to low.

As explained above with respect to the operation of the mutex 134, the request to acquire the mutex 134 by the control circuitry 130 will only be granted once the mutex 134 is released by the repeating process 110. This occurs at the signal transition labelled 360 in FIG. 4 when the first mutex-grant output G1 switches to low, after the second performance of the repeating process 110 shown in FIG. 4 has completed.

At the signal-transition labelled 358 in FIG. 3 and FIG. 4, the internal signal ackRun switches to a low state to indicate to the interface circuitry 132 that the repeating process 110 is no longer running, caused by the second mutex-grant output G2 switching to a high state, indicating that the mutex 134 has been acquired by the control circuitry 130.

In response to ackRun being set to low, the interface circuitry 132 sets the output signal ackSystem to a high state at the signal transition labelled 346 in FIGS. 3 and 4, thus providing an indication to the controlling process 140 that the repeating process 110 has been interrupted. In response to this indication, the controlling process 140 sets the input signal reqSystem to low, thus de-asserting the request to initiate the repeating process 110 which was previously raised. This controlling system 140 can thereafter set the input signal reqSystem to high again when the repeating process 110 is required to start running again.

It will be appreciated by those skilled in the art that the disclosure has been illustrated by describing one or more specific embodiments, but is not limited to these embodiments; many variations and modifications are possible, within the spirit and scope of the disclosure.

We claim:

1. Asynchronous hardware control circuitry for interrupting a succession of performances of a hardware or software process, the asynchronous hardware control circuitry comprising:
a first input for receiving an indication that a performance of a hardware or software process has completed and for receiving an indication of readiness to start a next performance of the process;
a second input for receiving a request to interrupt a succession of performances of the process;
a first output for outputting a request to start the next performance of the process; and
a hardware mutex, switchable between at least a first acquired state, a second acquired state and an unacquired state;
wherein the asynchronous hardware control circuitry is configured:
in response to receiving, at the first input, an indication of readiness to start a next performance of the process, if the mutex is in the unacquired state, to switch the mutex to the first acquired state and output, from the first output, a request to start the next performance of the process, and, if the mutex is in the second acquired state, not to output the request to start the next performance of the process;
in response to receiving, at the first input, an indication that a performance of the process has completed, if the mutex is in the first acquired state, to release the mutex from the first acquired state; and
in response to receiving, at the second input, a request to interrupt the succession of performances of the process:
if the mutex is in the unacquired state, to switch the mutex to the second acquired state; and
if the mutex is in the first acquired state, to cause the mutex to switch into the second acquired state after the mutex is released from the first acquired state.

2. The asynchronous hardware control circuitry of claim 1, wherein all of the asynchronous hardware control circuitry is un-clocked circuitry.

3. The asynchronous hardware control circuitry of claim 1, further comprising a third input for receiving a request to initiate the succession of performances of the process, wherein the asynchronous hardware control circuitry is configured, in response to receiving, at the third input, a request to initiate the succession of performances of the process, if the mutex is in the second acquired state, to release the mutex from the second acquired state.

4. The asynchronous hardware control circuitry of claim 1, wherein:
the mutex comprises a first mutex-request input comprising a single line implemented in hardware which is configured to be switched between being asserted and de-asserted; and
the mutex comprises a second mutex-request input comprising a single line implemented in hardware which is configured to be switched between being asserted and de-asserted;
wherein the asynchronous hardware control circuitry is configured to:
switch the mutex to the first acquired state by asserting the first mutex-request input;
release the mutex from the first acquired state by de-asserting the first mutex-request input;
switch the mutex to the second acquired state by asserting the second mutex-request input; and
release the mutex from the second acquired state by de-asserting the second mutex-request input.

5. The asynchronous hardware control circuitry of claim 4, comprising an interface logic portion connected to the second input and connected to the second mutex-request input, wherein the interface logic portion is configured, in response to receiving, at the second input, a request to interrupt the succession of performances of the process, to assert the second mutex request input.

6. The asynchronous hardware control circuitry of claim 4, comprising a third input for receiving a request to initiate the succession of performances of the process, and comprising an interface logic portion connected to the third input and connected to the second mutex-request input, wherein the interface logic portion is configured, in response to receiving, at the third input, a request to initiate the succession of performances of the process, to de-assert the second mutex-request input.

7. The asynchronous hardware control circuitry of claim 1, wherein the first output is further configured for outputting an acknowledgement of an indication that a performance of the process has completed, and wherein the asynchronous hardware control circuitry is configured, in response to the mutex being released from the first acquired state following the receipt of an indication that a performance of the process has completed, to output, from the first output, an acknowledgement of the indication that the performance has completed.

8. The asynchronous hardware control circuitry of claim 1, further comprising a second output for outputting an acknowledgement of the request to interrupt the succession of performances of the process and for outputting an indication that the process is running, wherein the asynchronous hardware control circuitry is configured:
in response to the mutex being switched to the first acquired state, to output, from the second output, an indication that the process is running; and
in response to receiving, at the second input, a request to interrupt the succession of performances of the process, to output, from the second output, an acknowledgment of the request to interrupt the succession of performances of the process.

9. The asynchronous hardware control circuitry of claim 1, further comprising a third output for outputting an indication that the succession of performances of the process has been interrupted, wherein the asynchronous hardware control circuitry is configured, in response to determining that the mutex has been switched to the second acquired state, to output, from the third output, an indication that the succession of performances of the process has been interrupted.

10. The asynchronous hardware control circuitry of claim 1, wherein the mutex comprises:
a first mutex-grant output comprising a single line implemented in hardware; and
a second mutex-grant output comprising a single line implemented in hardware; and
wherein the asynchronous hardware control circuitry is configured so that:
switching the mutex into the first acquired state causes a first mutex-grant output to be asserted;
releasing the mutex from the first acquired state causes the first mutex-grant output to be de-asserted;
switching the mutex into the second acquired state causes a second mutex-grant output to be asserted; and
releasing the mutex from the second acquired state causes the second mutex-grant output to be de-asserted.

11. An integrated circuit comprising:
processing circuitry configured for performing a succession of performances of a hardware or software process; and
asynchronous hardware control circuitry for interrupting the succession of performances of the hardware or software process,
wherein the asynchronous hardware control circuitry comprises:
a first input for receiving an indication that a performance of a hardware or software process has completed and for receiving an indication of readiness to start a next performance of the process;
a second input for receiving a request to interrupt a succession of performances of the process;
a first output for outputting a request to start the next performance of the process; and
a hardware mutex, switchable between at least a first acquired state, a second acquired state and an unacquired state; and
wherein the asynchronous hardware control circuitry is configured:
in response to receiving, at the first input, an indication of readiness to start a next performance of the process, if the mutex is in the unacquired state, to switch the mutex to the first acquired state and output, from the first output, a request to start the next performance of the process, and, if the mutex is in the second acquired state, not to output the request to start the next performance of the process;
in response to receiving, at the first input, an indication that a performance of the process has completed, if the mutex is in the first acquired state, to release the mutex from the first acquired state; and
in response to receiving, at the second input, a request to interrupt the succession of performances of the process:
if the mutex is in the unacquired state, to switch the mutex to the second acquired state; and
if the mutex is in the first acquired state, to cause the mutex to switch into the second acquired state after the mutex is released from the first acquired state.

12. The integrated circuit of claim 11, wherein the processing circuitry is in a first clock domain and wherein the asynchronous hardware control circuitry is asynchronous to the processing circuitry.

13. The integrated circuit of claim 11, wherein the asynchronous hardware control circuitry comprises an input for receiving a request to initiate the succession of performances of the process, and wherein the integrated circuit comprises an initiating subsystem configured to send a request to initiate the succession of performances of the process to the input.

14. The integrated circuit of claim 13, wherein the processing circuitry is in a first clock domain and the initiating subsystem is in a second clock domain different from the first clock domain.

15. The integrated circuit of claim 11, wherein the processing circuitry is communicatively coupled to the first input for sending the indication that a performance of the hardware or software process has completed and for sending the indication of readiness to start a next performance of the process.

16. The integrated circuit of claim 11, wherein the processing circuitry comprises:
a processing-circuitry-input for receiving, from the asynchronous hardware control circuitry, a request to start a next performance of the process and for receiving, from the asynchronous hardware control circuitry, an acknowledgement of an indication that a performance of the process has completed; and
a processing-circuitry-output for outputting, to the asynchronous hardware control circuitry, an indication that the performance has completed and for outputting, to the asynchronous hardware control circuitry, an indication of readiness to start a next performance of the process;
wherein the processing circuitry is configured:
in response to receiving, at the processing-circuitry-input, a request to start the next performance of the process, to carry out a performance of the process;
in response to completing the performance, to output, from the processing-circuitry-output, an indication that a performance of the process has completed; and
in response to receiving, at the processing-circuitry-input, an acknowledgement from the asynchronous hardware control circuitry of the indication that the performance has completed, to output, from the processing-circuitry-output, an indication of readiness to start a next performance of the process.

17. The integrated circuity of claim 11, wherein the processing circuitry is configured, after a performance has been carried out by the process, to output an indication of readiness to start the next performance of the process only in response to receiving, from the asynchronous hardware control circuitry, the acknowledgement of the indication that a performance of process has completed.
